(19) United States
(12) Patent Application Publication
(10) Pub. No.: US 2014/0116931 A1
(43) Pub. Date: May 1, 2014

(54) Suction-Type oil filter unit for transmissions or internal combustion engines

(71) Applicant: IBS Filtran Kunststoff-/Metallerzeugnisse GmbH, Morsbach (DE)

(72) Inventors: Markus Beer, Morsbach (DE); Marc BUCHEN, Morsbach (DE); Joerg KLUESER, Friesenhagen (DE); Wolfgang STAUSBERG, Morsbach (DE)

(21) Appl. No.: 13/908,711

(22) Filed: Jun. 3, 2013

(30) Foreign Application Priority Data
Jun. 4, 2012 (DE) 10 2012 010939.3

(51) Int. Cl. B01D 29/88

(52) U.S. Cl. CPC B01D 29/88
USPC 210/196

(57) ABSTRACT

The invention relates to a suction-type oil filter unit (1) for transmissions or internal combustion engines, having an oil filter housing (2) composed of plastic, wherein the oil filter housing has at least one suction duct (9), which can be connected to a suction pump, and at least one return duct (8) for a pressurized oil volume flow returned from the suction pump for the purpose of induction charging of the pump suction oil flow. The return duct (8) is provided, in the region of its mouth into the suction duct (9), with at least one nozzle device. The suction-type oil filter unit (1) is characterized in particular in that the nozzle device has at least one nozzle body (10) which is inserted into the return duct (8) and which is not formed in one piece with the return duct (8) and which surrounds a nozzle bore.

The invention relates to a suction-type oil filter unit for transmissions or internal combustion engines, having an oil filter housing composed of plastic, which oil filter housing has at least one suction duct, which can be connected to a suction pump, and at least one return duct for a pressurized oil volume flow returned from the suction pump for the purpose of induction charging of the pump suction oil flow, wherein the return duct is provided, in the region of its mouth into the suction duct, with at least one nozzle device.

An oil filter unit of said type with integrated suction flow charging is known for example from DE 10 2009 050 330 A1. The oil filter unit described in DE 10 2009 050 330 A1 comprises a two-part oil filter housing with an oil outlet which is in the form of a connector and to which can be connected a suction pump which delivers an oil volume flow or filter oil volume flow through a filter medium arranged in the oil filter housing.

To achieve greater efficiency of the suction pump, it is expedient and known for the oil volume flow conducted to the pump inlet to be assisted by means of a targetedly guided fluid jet, whereby the cavitation point of the suction pump is shifted such that the occurrence of cavitation at the suction pump is avoided. Since, at high rotational speed, the suction pump delivers more pressurized oil or a greater pressurized oil volume flow than is actually required in the transmission or in the internal combustion engine, it is provided in the case of the known suction flow charging that the excess pressurized oil or at least a proportion thereof is returned into the suction duct flow upstream of the suction pump. For this purpose, in the return duct, in the region of the mouth thereof into the suction duct, there is arranged a nozzle device which is conventionally in the form of an integral branch of the suction duct. The suction duct is in the form of an injection-moulded part which is manufactured from plastic and which is formed integrally with the filter upper shell.

For the supply of the pressurized oil volume flow to the suction oil volume flow, a curved configuration of the return duct or of the charging connection on the suction duct is desirable. In particular in the case of a lateral arrangement of the return duct, a curved configuration into the suction duct is attained which is expedient from a flow aspect.

Such a lateral connection of the charging duct or return duct is described for example in DE 10 2007 027 222 B4. DE 10 2007 027 222 B4 relates to a connection arrangement for the connection of a suction side of an oil pump arranged in a housing of a vehicle transmission, wherein a separate induction connector is provided with an integrated induction charging arrangement, wherein the induction connector comprises a tubular main body with an induction duct and an induction channel, the induction channel connects the induction side of the oil pump to an induction snorkel, the induction duct connects the induction side of the oil pump to a charging connection of the induction connector, the charging connection is arranged laterally on the main body, and the charging connection is connected directly to the hydraulic control unit of the vehicle transmission, wherein the charging duct opens into the induction duct within the induction connector in such a way that an outlet opening, which opens into the induction duct, of the charging duct has a cross section which is not rotationally symmetrical.

As has already been described in this document, a crucial factor in the configuration of a suction flow charging arrangement is the orientation with which the pressurized oil volume jet is introduced into the suction duct.

The configuration of the connection of the return duct to the suction duct of the oil pump is however subject to practical limits from a production aspect, in particular if said parts are formed integrally from thermoplastic materials.

The invention is therefore based on the object of further developing a suction-type oil filter unit of the type mentioned in the introduction in such a way as to provide the greatest possible configuration/design freedom with regard to the guidance of the pressurized oil volume flow for suction flow charging.

The object is achieved by means of a suction-type oil filter unit for transmissions or internal combustion engines, having an oil filter housing composed of plastic, preferably thermoplastic material, which oil filter housing has at least one suction duct, which can be connected to a suction pump, and at least one return duct for a pressurized oil volume flow returned from the suction pump for the purpose of induction charging of the pump suction oil flow, wherein the return duct is provided, in the region of its mouth into the suction duct, with at least one nozzle device, wherein the suction-type oil filter unit according to the invention is characterized in that the nozzle device has at least one nozzle body which is inserted into the return duct and which is not formed in one piece with the return duct. As a result of the arrangement according to the invention, there is a substantial amount of design freedom with regard to material orientation and design of the nozzle device. To significantly increase the design freedom with regard to the configuration of the nozzle, it is provided according to the invention that the nozzle is designed as a separate inlay part or as a separate insert. In this way, it is achieved that the material and the form of the nozzle can be selected independently of the filter housing. At the same time, the restrictions that inevitably arise when using a tool which forms the image of a single-piece filter housing with integrated nozzle are eliminated. In this way, the nozzle geometry can be adapted in an optimum fashion for its maximum possible effect.

In one advantageous and expedient embodiment of the suction-type oil filter unit according to the invention, it is provided that the suction duct and the return duct are, at least in sections, integral constituent parts of the oil filter housing. The suction duct and the return duct may for example be formed integrally with a housing upper shell of the suction-type oil filter unit, which has been obtained for example from thermoplastic materials by injection moulding.

In a particularly preferred embodiment of the suction-type oil filter unit, it is provided that the nozzle body is plugged into the return duct.

The nozzle body may for example be sealed off in the return duct by a sealing means. Said nozzle body may for example also be centred in the return duct by the sealing means.

The nozzle body may be latched in the return duct.

In a particularly preferred and expedient refinement of the suction-type oil filter unit according to the invention, it is provided that the return duct has a circular, rotationally symmetrical clear cross section, and that the nozzle body is adapted in terms of cross section to the return duct.

In a refinement of the nozzle body which is advantageous with regard to assemblability, said nozzle body, in the installed position, is held between an encircling shoulder of the mouth of the return duct and a pressurized oil supply connector, wherein the pressurized oil supply connector is plugged into the return duct. The return duct preferably has a portion which is widened or flared in the manner of a sleeve in cross section and into which the pressurized oil supply connector is inserted. The nozzle body is expediently held on one side by the encircling shoulder in the return duct and on the other side by an end surface of a pressurized oil supply connector.

In one particularly advantageous variant of the suction-type oil filter unit according to the invention, it is provided that the return duct and the nozzle body are provided with means for indexing, which means permit an insertion of the nozzle body into the return duct in only one orientation. In this way, it is possible for the nozzle opening to be formed with any desired nozzle contour, the correct orientation of which is ensured in the installed position of the nozzle body by the indexing.

In one preferred variant of the suction-type oil filter unit according to the invention, the nozzle geometry is not rotationally symmetrical, such that, in this respect, guidance of the charging volume flow or pressurized oil flow into the suction oil flow is possible in such a way that an optimum acceleration of the suction oil flow is attained. In one expedient refinement of the suction-type oil filter unit according to the invention, it is provided that the nozzle body has, on its outer circumference, at least one encircling groove which receives at least one sealing ring, for example an O-ring.

The invention will be explained below on the basis of an exemplary embodiment illustrated in the drawings, in which:

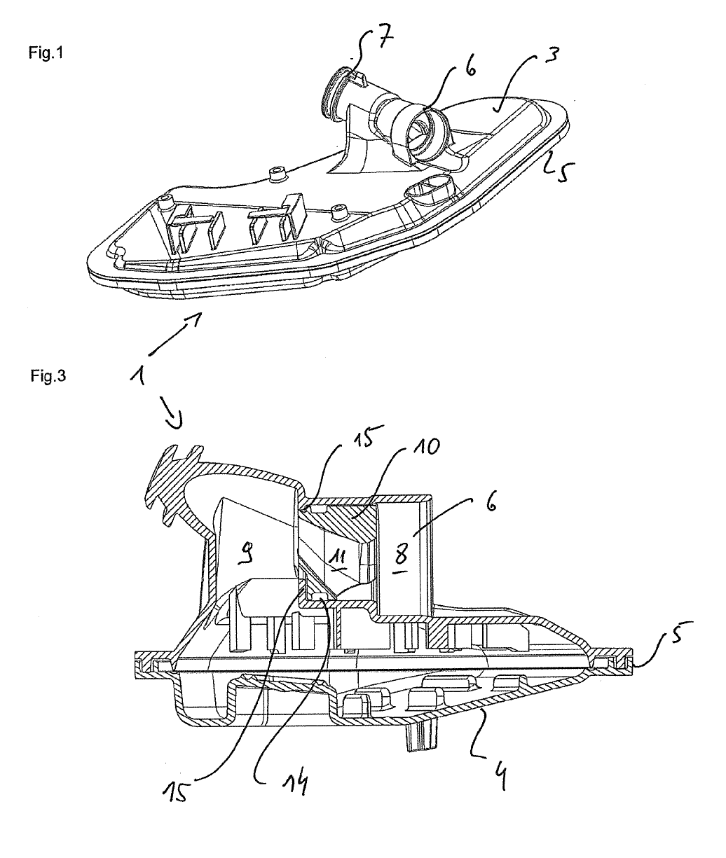

FIG. 1 shows a suction-type oil filter unit according to the invention in a perspective view from above,

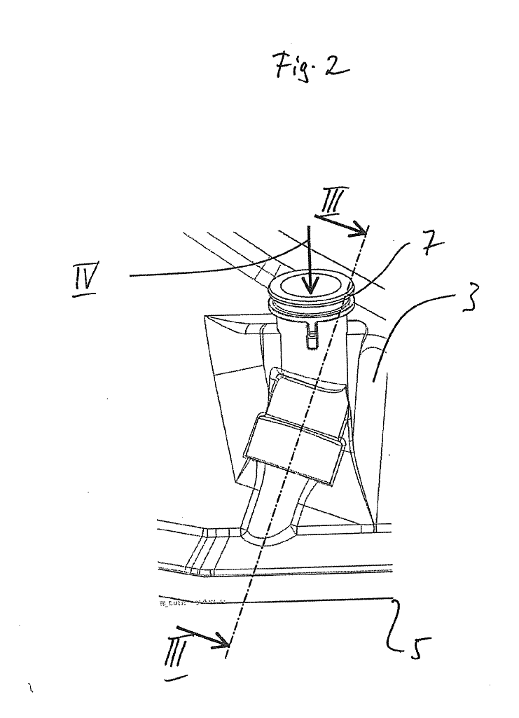

FIG. 2 shows a perspective detail view of the upper shell of the oil filter housing,

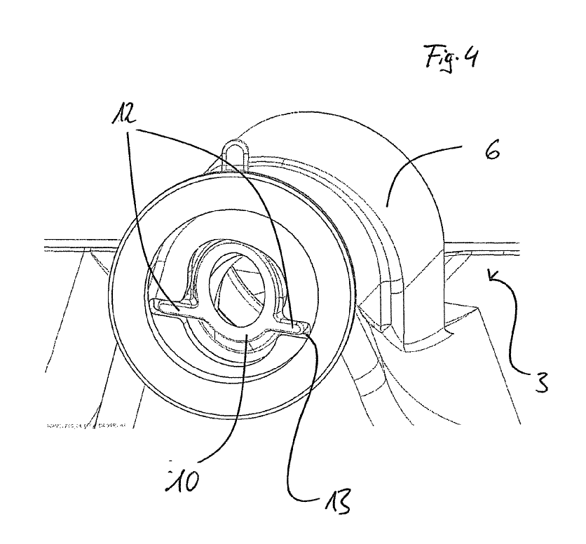

FIG. 3 shows a sectional view along the lines III-III in FIG. 2, and

FIG. 4 shows a view in the direction of the arrow IV in FIG. 2.

The suction-type oil filter unit 1 according to the invention comprises an oil filter housing 2 with a filter housing upper shell 3 and a filter housing lower shell 4 which are connected to one another in an oil-tight manner at an encircling flange and which enclose a volume within which a filter medium (not illustrated) is arranged.

The suction-type oil filter unit is, as a whole, arranged for example in the oil sump of an automatic transmission or of an internal combustion engine. Where reference is made below to oil as fluid, this should also be understood to encompass so-called ATF (automatic transmission fluid).

The filter housing upper shell 3 and the filter housing lower shell 4 are injection-moulded from thermoplastic material and are welded to one another at the edge in an encircling manner.

Integrally formed on the filter housing upper shell 3 are a pressure connector 6 and a suction connector 7, wherein the pressure connector 6 forms a part of a return duct 8, and the suction connector 7 forms a part of a suction duct 9. An oil delivery pump (not illustrated) can be connected to the suction connector 7 directly or via an induction connector. To the pressure connector 6 there is connected a pressurized oil supply pipe which is connected to the pressure side of the oil pump and in which a partial flow of the delivery volume flow of the oil pump is returned for the purpose of charging the suction flow.

The pressurized oil supply pipe is part of the return duct 8, which is formed otherwise as a constituent part of the filter housing upper shell 3.

The suction duct 9 and also the suction connector 7 are integral constituent parts of the filter housing upper shell, wherein a part of the suction duct 9 is guided within the oil filter housing 2.

As can be seen in particular from the plan view of the suction connector 7 illustrated in FIG. 4, a nozzle body 10 is inserted into the pressure connector 6. The position of the nozzle body 10 can also be seen from the sectional view shown in FIG. 3. The nozzle body is of substantially cylindrical form and is fitted into the cylindrical cross section of the return duct 8. The nozzle bore 11 which extends through the nozzle body 10 is, by contrast, not of rotationally symmetrical form and tapers in the region of the mouth of the return duct 8 into the suction duct 9, in order thereby to effect an increase of the flow speed of the pressurized oil volume flow entering the suction duct 9.

The cross-sectional geometry of the nozzle bore 11 is configured such that the returned oil volume flow is introduced laterally into the suction duct 9.

As can be seen in particular from FIG. 4, two diametrically opposite, radially outwardly protruding webs 12 are provided on the outside of the nozzle body, which webs engage, as indexing aids, into correspondingly formed grooves 13 on the inner circumference of the return duct 8.

Furthermore, the nozzle body 10 is provided, on its outer circumference, with an encircling annular groove which receives an O-ring (not illustrated) as sealing means.

As can likewise be seen from FIG. 3, the pressure connector 6 is, on its side facing away from the suction duct 9, slightly widened or flared in the manner of a sleeve in cross section, in order to receive therein a plug-in end of the above-mentioned pressurized oil supply pipe (not illustrated). The nozzle body is plugged into the return duct, which is of circular and rotationally symmetrical cross section, when the pressurized oil supply pipe is not mounted, wherein the O-ring seal (not illustrated) comes into sealing abutment with the inner circumference of the return duct. In the region of the mouth of the return duct 8 into the suction duct 9, the return duct 8 is provided with an encircling, inwardly projecting collar 15 which forms a stop for the nozzle body 10. The O-ring seal may be dimensioned such that the nozzle body is centred within the return duct 8 substantially also by the O-ring seal.

Locking of the nozzle body 10 within the return duct 8 is at any rate not required when said nozzle body is held by the end side of the return pipe inserted into the pressure connector 6.

### REFERENCE NUMERALS

1 Suction-type oil filter unit

2 Oil filter housing

3 Filter housing upper shell

4 Filter housing lower shell

5 Flange

6 Pressure connector

7 Suction connector

8 Return duct

9 Suction duct

10 Nozzle body

11 Nozzle bore

12 Webs

13 Grooves

14 Annular groove

15 Collar

1. (canceled)

2. (canceled)

3. (canceled)

4. (canceled)

5. (canceled)

6. (canceled)

7. (canceled)

8. (canceled)

9. (canceled)

10. Suction-type oil filter unit for transmissions or internal combustion engines, having an oil filter housing composed of plastic, which oil filter housing has at least one suction duct, which can be connected to a suction pump, and at least one return duct for a pressurized oil volume flow returned from the suction pump for the purpose of induction charging of the pump suction oil flow, wherein the return duct is provided, in the region of its mouth into the suction duct, with at least one nozzle device, characterized in that the nozzle device has at least one nozzle body which is inserted into the return duct and which is not formed in one piece with the return duct.

11. Suction-type oil filter unit according to claim 10, characterized in that the suction duct and the return duct are, at least in sections, integral constituent parts of the oil filter housing.

12. Suction-type oil filter unit according to claim 10, characterized in that the nozzle body is plugged into the return duct.

13. Suction-type oil filter unit according to claim 10, characterized in that the nozzle body is sealed off in the return duct by a sealing means.

14. Suction-type oil filter unit according to claim 10, characterized in that the return duct has a circular clear cross section, and in that the nozzle body is adapted in terms of cross section to the return duct.

15. Suction-type oil filter unit according to claim 10, characterized in that the nozzle body, in the installed position, is held between an encircling shoulder of the mouth of the return duct and a pressurized oil supply pipe which is inserted into a portion, which is flared in the manner of a sleeve, of the return duct.

16. Suction-type oil filter unit according to claim 10, characterized in that the return duct and the nozzle body are provided with means for indexing, which means permit an insertion of the nozzle body into the return duct in only one orientation.

17. Suction-type oil filter unit according to claim 10, characterized in that the nozzle body surrounds a nozzle duct whose geometry is not rotationally symmetrical.

18. Suction-type oil filter unit according to claim 10, characterized in that the nozzle body has, on its outer circumference, at least one encircling annular groove which receives at least one sealing ring.
